(19) United States
(12) Patent Application Publication
(10) Pub. No.: US 2013/0219209 A1
(43) Pub. Date: Aug. 22, 2013

(54) ELECTRONIC DEVICE WITH AN OVERCLOCKING MODE AND METHOD

(71) Applicants: YUAN-XI CHEN, Shenzhen City (CN); YING-BIN FU, Shenzhen City (CN)

(72) Inventors: YUAN-XI CHEN, Shenzhen City (CN); YING-BIN FU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/427,924

(22) Filed: Mar. 23, 2012

(30) Foreign Application Priority Data
Feb. 16, 2012 (CN) 201210034787.4

(51) Int. Cl. G06F 1/04

(52) U.S. Cl. 713/600

(57) ABSTRACT

An electronic device with an overclocking mode includes a processor, a memory storing a first range and a second range, and a digital controller which includes a first register, a second register, a monitor module, a determining module, a first writing module, an implementing module, and a second writing module. The monitor module monitors a value of current of the processor. The determining module determines whether the current is within the first range. The first writing module writes the current value in the first register. The implementing module reduces a value from the current value to acquire a new current value. The second writing module writes the new current value in the second register. The processor reads the new current value, detects whether the new current value is within the second range, and keeps itself in the overclocking mode when the new current value is within the second range.

### BACKGROUND

1. Technical Field

The present disclosure relates to electronic devices and, particularly, to an electronic device with an overclocking mode and a method of overclocking mode.

2. Description of Related Art

In a prior art, in order to improve a whole capability of a processor, the processor usually works in an overclocking mode. However, the processor usually automatically generates an instruction to depress a working frequency of the processor to switch the processor from the overclocking mode to a non-overclocking mode when the processor works in the overclocking mode, which results in a lower capability of the processor.

Therefore, what is needed is an electronic device to overcome the described limitations.

### BRIEF DESCRIPTION OF THE DRAWINGS

FIG. 1 is a block diagram of the hardware infrastructure of an electronic device with an overclocking mode, in accordance with an exemplary embodiment.

FIG. 2 is a flowchart of a method for controlling an overclocking mode implemented by the electronic device of FIG. 1, in accordance with an exemplary embodiment.

### DETAILED DESCRIPTION

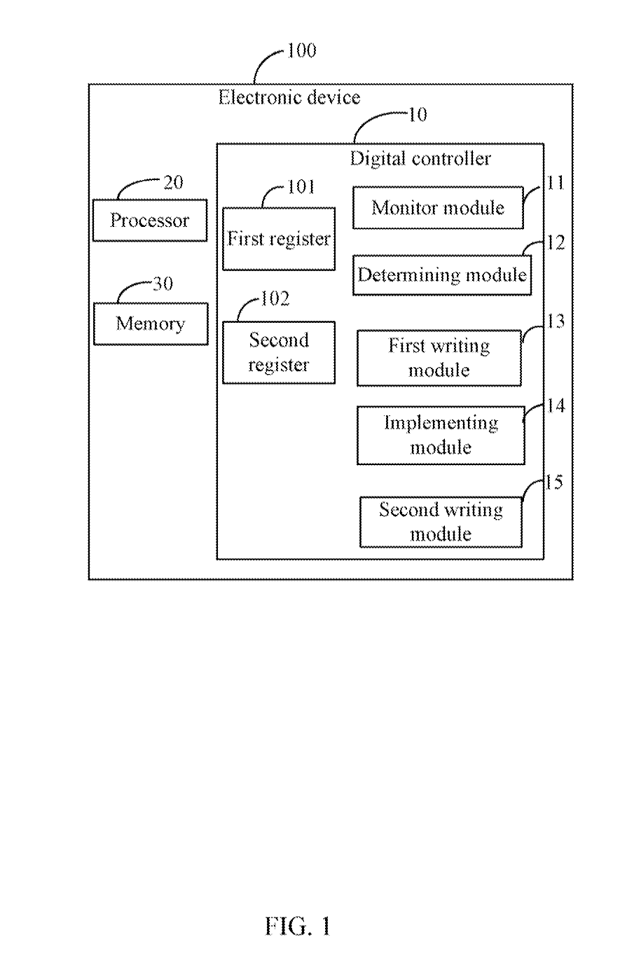

FIG. 1 shows an electronic device 100 with an overclocking mode. The electronic device 100 includes a digital controller 10, a processor 20, and a memory 30. The digital controller 10 includes a first register 101 and a second register 102. The processor 20 works between an overclocking mode and a non-overclocking mode. The memory 30 stores a first range of a value of a working current of the processer 20 in the overclocking mode, and a second range of the value of the working current of the processor 20 in the non-overclocking mode.

The digital controller 10 includes a monitor module 11, a determining module 12, a first writing module 13, an implementing module 14, and a second writing module 15.

The monitor module 11 monitors the value of the working current of the processor 20. The determining module 12 determines whether the value of the working current is within the first range. The first writing module 13 writes the value of the working current in the first register 101 when the value of the working current is within the first range. The implementing module 14 decreases a value from the value written in the first register 101 to acquire a new value of the working current. The second writing module 15 writes the new value of the working current in the second register 102. The processor 20 reads the new value of the working current from the second register 102, detects whether the new value of the working current is within in the second range, and keeps itself in the overclocking mode when the new value of the working current is within in the second range.

For example, when the processor 20 is in the non-overclocking mode, the second range of the value of the working current of the processor 20 is from 1 A to 10 A; when the processor 20 is in the overclocking mode, the first range of the value of the working current of the processor 20 is from 11 A to 15 A. Suppose, the value of the working current of the processor 20 monitored by the monitor module 11 is 13 A, and a working frequency of processor 20 is 2.3 GHZ corresponding to the working current 13A. Because the value of the working current 13A is within the first range, the value of the working current 13A is written by the first writing module 13 in the first register 101. The implementing module 14 decreases a value 4A from the value of the working current 13A to acquire a new value of the working current 9A which is written by the second writing module 15 in the second register 102. Then, the processor 20 reads the new value of the working current 9A, and detects whether the new value of the working current 9A is within the second range. If it is apparent that the new value of the working current 9A is within the second range, the processor 20 will keep itself in the overclocking mode. That is, although the processor 20 is already in the overclocking mode based on the working current 13A, the processor 20 does not depress the working frequency of the processor 20. Therefore, the processor 20 may stay in the overclocking mode for a long time, thereby improving a whole capability of the processor 20. However, in prior art, the conventional processor will directly read the value of the working current 13A, and detect whether the value of the working current 13A is within the second range. It is apparent that the value of the working current 13A is out of the second range, so, the conventional processor depresses the working frequency of itself to switch the conventional processor from the overclocking mode to the non-overclocking mode. That is, the conventional processor cannot work in the overclocking mode for the long time.

In one embodiment, the implementing module 14 further decreases another value from the new value of the working current to acquire a new value of the working current when the new value of the working current in the second register is out of the second range. The second writing module 15 further writes the new value of the working current in the second register 102 to replace a previous value of the working current. The processor 20 reads the new value of the working current from the second register 102, detects whether the new value of the working current is within in the second range, and keeps itself in the overclocking mode when the new value of the working current is within in the second range.

In one embodiment, the first writing module 13 further writes the value of the working current in the second register 102 when the value of the working current monitored by the monitor module 11 is within the second range. That is, when the value of the working current monitored by the monitor module 11 is within the second range, it means that the processor 20 is in the non-overclocking mode; there is no need to decrease a value from the value of the working current.

In one embodiment, when the value of the working current monitored by the monitor module 11 is out of the second range and the first range, the processor 20 generates an instruction to reduce the value of the working current until the monitored value of the working current is within the first range, thereby keeping the processor 20 in the overclocking mode. For example, the second range is from 0 A to 10 A, the first range is from 11 A to 15 A, the value of the working current of the processor 20 is 17 A, and the working frequency of the processor 20 is 2.7 GHZ. Because the value of the working current 17A is out of the first range, and the working frequency of the processor 20 is overloaded, which results in the processor 20 breaking down. So, it is needed for the processor 20 to generate the instruction to reduce the value of the working current until it is within the first range, thereby keeping the processor 20 in the overclocking mode, and preventing the processor 20 from breaking down.

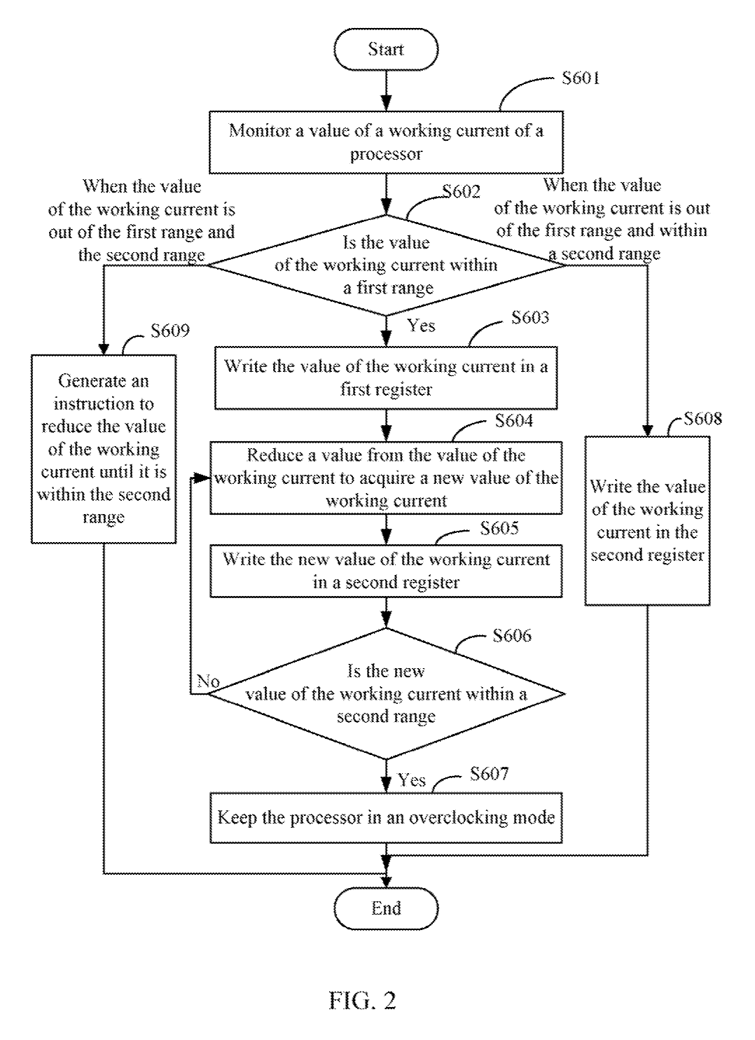

FIG. 2 is a flowchart of a method for controlling an overclocking mode implemented by the electronic device of FIG. 1, in accordance with an exemplary embodiment.

In step S601, the monitor module 11 monitors the value of the working current of the processor 20.

In step S602, the determining module 12 determines whether the value of the working current is within the first range, if yes, the procedure goes to step S603, if no, the procedure goes to step S608 when the value of the working current is out of the first range and within the second range, or the procedure goes to step S609 when the value of the working current is out of the first range and the second range.

In step S603, the first writing module 13 writes the value of the working current in the first register 101.

In step S604, the implementing module 14 decreases a value from the value of the working current in the first register 101 to acquire a new value of the working current.

In step S605, the second writing module 15 writes the new value of the working current in the second register 102.

In step S606, the processor 20 detects whether the new value of the working current in the second register 102 is within the second range, if yes, the procedure goes to step S607, if no, the procedure goes to step S604.

In step S607, the processor 20 keeps itself in the overclocking mode.

In step S608, the first writing module 13 writes the value of the working current in the second register 102.

In step S609, the processor 20 generates an instruction to reduce the value of the working current until the value of the working current is within the first range.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device with an overclocking mode, the electronic device comprising:
a processor working between an overclocking mode and a non-overclocking mode;
a memory storing a first range of a value of a working current of the processer in the overclocking mode, and a second range of the value of the working current of the processor in the non-overclocking mode; and
a digital controller comprising:
a first register;
a second register;
a monitor module configured to monitor the value of the working current of the processor;
a determining module configured to determine whether the monitored value of the working current is within the first range;
a first writing module configured to write the value of the working current in the first register when the monitored value of the working current is within the first range;
an implementing module configured to decrease a value from the value of the working current to acquire a new value of the working current; and
a second writing module configured to write the new value of the working current in the second register; and
wherein the processor is configured to read the new value of the working current from the second register, detect whether the new value of the working current is within the second range, and keep itself in the overclocking mode when the new value of the working current is within the second range.

2. The electronic device as described in claim 1, wherein the implementing module is further configured to reduce another value from the new value of the working current to acquire a new value of the working current when the new value of the working current written in the second register is out of the second range, the second writing module is further configured to write the new value of the working current in the second register, and the processor reads the new value of the working current from the second register, detects whether the new value of the working current is within the second range, and keeps itself in the overclocking mode when the new value of the working current is within the second range.

3. The electronic device as described in claim 1, wherein the first writing module is further configured to write the value of the working current in the second register when the value of the working current monitored by the monitor module is out of the first range and within the second range.

4. The electronic device as described in claim 3, wherein the processor is further configured to generate an instruction to reduce the monitored value of the working current until the monitored value of the working current value is within the first range.

5. A method for controlling an electronic device in an overclocking mode, wherein the electronic device comprises a processor working between an overclocking mode and a non-overclocking mode; a memory storing a first range of a value of a working current of the processer in the overclocking mode, and a second range of the value of the working current of the processor in the non-overclocking mode; and a digital controller comprising a first register and a second register, the method comprising:
monitoring the value of the working current of the processor;
determining whether the monitored value of the working current is within the first range;
writing the value of the working current in the first register when the monitored value of the working current is within the first range;
reducing a value from the value of the working current to acquire a new value of the working current; and
writing the new value of the working current in the second register; and
the processor reading the new value of the working current from the second register, detecting whether the new value of the working current is within the second range, and keeping itself in the overclocking mode when the new value of the working current is within the second range.

6. The method as described in claim 5, further comprising:
reducing another value from the new value of the working current to acquire a new value of the working current when the new value of the working current written in the second register is out of the second range; and
writing the new value of the working current in the second register; and
wherein the processor reads the new value of the working current from the second register, detects whether the new value of the working current is within the second range, and keeps itself in the overclocking mode when the new value of the working current is within the second range.

7. The method as described in claim 5, further comprising:
writing the value of the working current in the second register when the value of the monitored working current is out of the first range and within the second range.

8. The method as described in claim 7, further comprising:
the processor generating an instruction to reduce the monitored value of the working current until the monitored value of the working current is within the first range.
